(19) United States
(12) Patent Application Publication
(10) Pub. No.: US 2020/0159810 A1
(43) Pub. Date: May 21, 2020

(54) PARTITIONING SPARSE MATRICES BASED ON SPARSE MATRIX REPRESENTATIONS FOR CROSSBAR-BASED ARCHITECTURES

(71) Applicant: Hewlett Packard Enterprise Development LP, Houston, TX (US)

(72) Inventors: Chinmay Ghosh, Bangalore (IN); Soumitra Chatterjee, Bangalore (IN); Mashood Abdulla Kodavanji, Bangalore (IN); Mohan Parthasarathy, Bangalore (IN)

(21) Appl. No.: 16/191,767

(22) Filed: Nov. 15, 2018

(51) Int. Cl. G06F 17/16; G06F 9/50; G06F 9/30; G06F 9/38

(52) U.S. Cl. CPC G06F 17/16; G06F 9/3822; G06F 9/30036; G06F 9/5077

(57) ABSTRACT

Example implementations relate to domain specific programming language (DSL) compiler for large scale sparse matrices. A method can comprise partitioning a sparse matrix into a plurality of submatrices based on a sparse matrix representation and inputting each one of the submatrices into a respective one of a plurality of matrix-vector multiplication units (MVMUs) of a crossbar-based architecture.

### BACKGROUND

A dot product engine (DPE) may perform matrix-vector multiplication (MVM) operations that consume large quantities of memory and computational resources. Sparse matrix representations may be used to store only non-zero elements of a sparse matrix to reduce the consumption of memory and computational resources.

### BRIEF DESCRIPTION OF THE DRAWINGS

FIG. 1 illustrates an example DPE consistent with the disclosure.

FIG. 2 illustrates an example schematic of development environment for a neural network implemented on a DPE consistent with the disclosure.

FIG. 3 is an example computation graph consistent with the disclosure.

FIG. 4 illustrates an example compressed sparse row (CSR) representation of a sparse matrix consistent with the disclosure.

FIG. 5 illustrates example partitioning of a sparse matrix into submatrices consistent with the disclosure.

FIG. 6 illustrates an example iteration through a CSR representation of a sparse matrix consistent with the disclosure.

FIG. 7 is a graph showing example memory savings consistent with the disclosure.

FIG. 8 is a block diagram of an example system consistent with the disclosure.

FIG. 9 illustrates an example method consistent with the disclosure.

### DETAILED DESCRIPTION

A DPE is an example of a crossbar-based architecture. A DPE is a high-density, power efficient accelerator that utilizes the current accumulation feature of a memristor crossbar. A DPE, together with a fast conversion algorithm, can accelerate MVM in robust applications that do not use high computing accuracy such as neural networks. This approach to performing MVM operations in the analog domain can be orders of magnitude more efficient than digital application-specific integrated circuit (ASIC) approaches, especially increased crossbar array sizes.

A software development environment can be used to develop neural network models, targeting the DPE architecture, that take advantage of the parallel crossbars of the DPE architecture for performing MVM operations. The software development environment can use a domain specific programming language (DSL) and include a compiler that compiles a program written in a DSL into a DPE binary format and a loader that transfers data and instructions to the DPE and includes supporting libraries.

Sparse matrices and methods for using sparse matrices efficiently can be critical to the performance of many applications. As a result, sparse MVM operations can be of importance in computational science. Sparse MVM operations can represent a significant cost of iterative methods for solving large-scale linear systems, eigenvalue problems, and convolutional neural networks. Examples of sparse matrices include link matrices for links from one website to another and term occurrence matrices for words in an article against all known words in English.

Large scale sparse matrices can be a challenge in computations, such as MVM operations, because of the large memory and computational resource requirements of the computations. To avoid this challenge, sparse matrix representations, such as a CSR representation, that store only the non-zero elements of the sparse matrix can be used to reduce the consumption of memory and computational resources. Previous approaches to sparse matrix representations do not include partitioning of a sparse matrix without rebuilding the sparse matrix in memory.

The disclosure enables a DPE DSL compiler to recognize sparse matrix representations, including but not limited to CSR, coordinate list (COO), compressed sparse column (CSC), ELLPACK (ELL), diagonal (DIA), and hybrid (HYB) ELL+COO. The disclosure includes partitioning a sparse matrix into denser (more non-zero elements than zero elements) submatrices suitable for crossbars of a DPE without expanding the CSR notation back into the complete sparse matrix, which can improve use of host memory and reduce data transfer to memory of a DPE. Because only submatrices with non-zero valued elements are considered, use of crossbar resources can be optimized, thereby enabling scaling to large-scale sparse matrices.

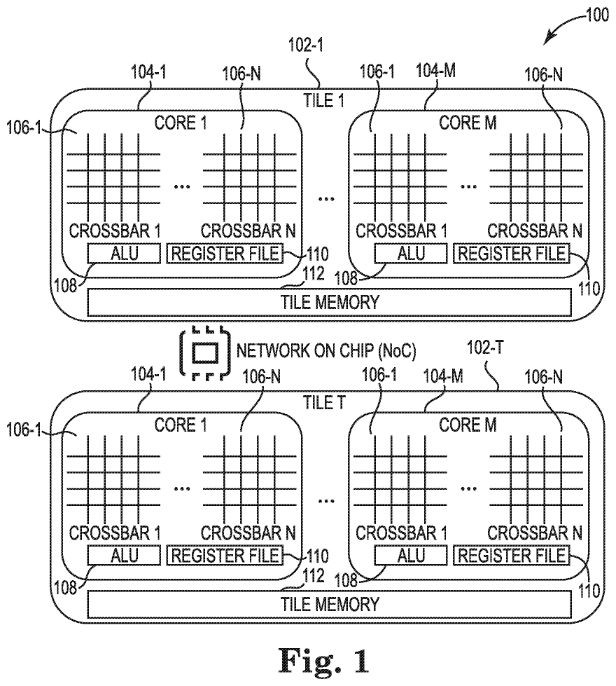

FIG. 1 illustrates an example DPE 100 consistent with the disclosure. The DPE 100 can be a Network on Chip (NoC). The DPE 100 includes a plurality of tiles 102-1 . . . 102-T (collectively referred to as the tiles 102). Each respective one of the tiles 102 can include a plurality of cores 104-1 . . . 102-M (collectively referred to as the cores 104) and memory 112. Each respective one of the cores 104 can include a plurality of crossbars 106-1 . . . 106-N (collectively referred to as the crossbars 106), an algorithmic logic unit (ALU) 108, and a register file 110. Each respective one of the cores 104 has its own memory, but the memory 112 of each respective one of the tiles 102 is larger. A crossbar may be referred to as a matrix-vector multiplication unit (MVMU) that performs MVM operations in an analog domain. As described herein, a sparse matrix can be partitioned into a plurality of submatrices according to a sparse matrix representation of the sparse matrix. Each respective submatrix can be input to one of the crossbars 106.

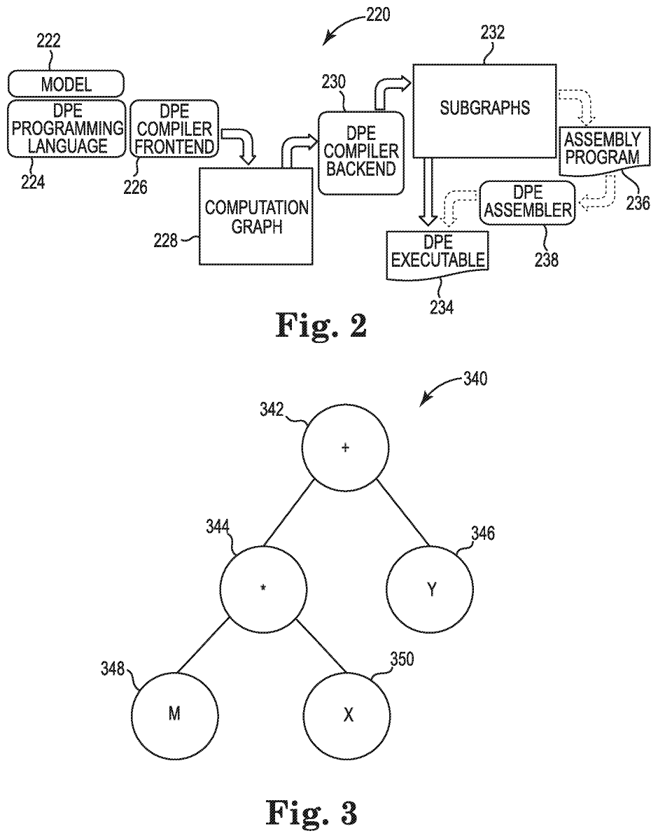

FIG. 2 illustrates an example schematic 220 of development environment for a neural network implemented on a DPE consistent with the disclosure. A neural network model 222 can be described using DPE programming language 224. The neural network model 222 can be input to a DPE compiler frontend 226 to generate a computation graph 228 of the neural network model 222. The computation graph 228 is input to a DPE compiler backend 230. The DPE compiler 230 can partition and optimize the computation graph 228 into a plurality of subgraphs 232. The subgraphs 232 can be a component of a DPE executable 234. The subgraphs 232 can be input to an assembly program 236. The output of the assembly program is input to a DPE assembler 238. The output of the DPE assembler 238 can be a component of the DPE executable 234.

The DPE programming language 224 can be a DSL that is defined by a set of data structures and application program interfaces (APIs). A non-limiting example of a DSL is a programming language based on C++ that is standardized by the International Organization for Standardization (ISO C++). The data structures and APIs can be building blocks of neural network algorithms implemented on a DPE, such as the DPE 100 described in association with FIG. 1 above. A DSL can provide a set of computing elements, which may be referred to as tensors, and operations defined over the tensors. Tensors can include constructs such as scalars, vectors, and matrices. As used herein, “scalars” refer to singular values, “vectors” refer to one-dimensional sets of elements or values, and “matrices” refer to two-dimensional sets of elements or values.

Operations to be performed on tensors as described by the DSL are captured by the computation graph 228. Each individual operation can be represented by one of the subgraphs 232. The computation graph 228 can be compiled into the DPE binary executable 234. The DPE binary executable 234 can be transferred for execution on a DPE, for example, by a loader component.

FIG. 3 is an example computation graph 340 consistent with the disclosure. The computation graph 340 can be analogous to the computation graph 228 shown in FIG. 2. The computation graph 340 represents the following expression: (M*X)+Y. As shown in FIG. 3, inputs M, X, and Y are represented by the nodes 348, 350, and 346, respectively. The multiplication operation on M and X is represented by the node 344, which is connected to the nodes 348 and 350. M can be a submatrix and X can be a subvector. The addition operation on the result of the multiplication operation on M and X is represented by the node 342, which is connected to the nodes 344 and 346. The result of the addition operation is dependent on the result of the multiplication.

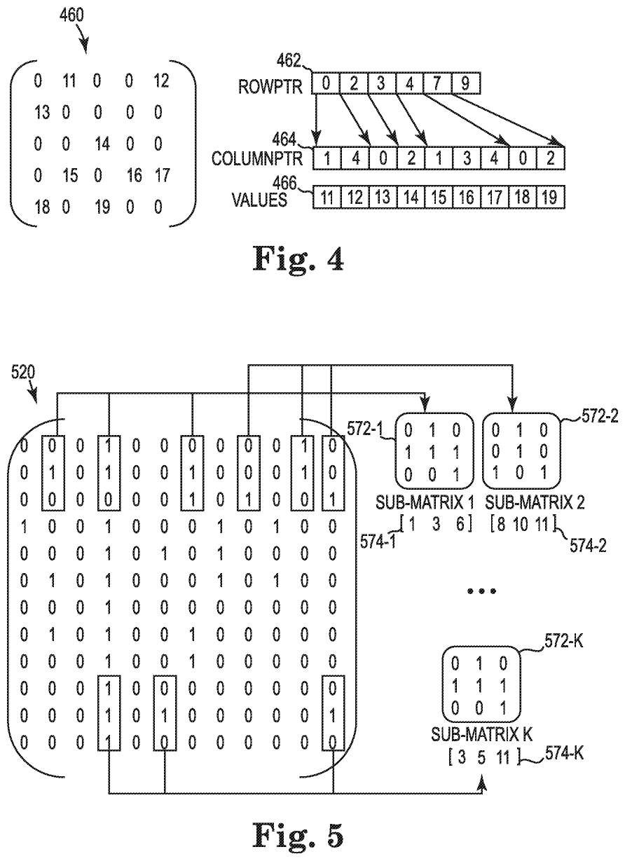

FIG. 4 illustrates an example CSR representation of a sparse matrix consistent with the disclosure. A CSR representation can use three arrays to describe a sparse matrix. A first array of the CSR representation (also referred to as a row pointer) can include the position of starting non-zero element of a row in a second array. The second array can include of the CSR representation (also referred to as a column pointer) includes the column indices of the sparse matrix that include non-zero elements. A third array of the CSR representation can include the values of the non-zero elements of the sparse matrix.

FIG. 4 illustrates the CSR representation of the sparse matrix 460. The sparse matrix 460 includes two non-zero values in row 0 at columns 1 and 4. Accordingly, as shown in FIG. 4, the row pointer (RowPtr) 462 includes row index 0 that points to the column pointer (ColumnPtr) 464 that includes ccolumn indices 1 and 4. The values of those non-zero elements, 11 and 12 respectively, are elements of the array 466.

The sparse matrix 460 includes a non-zero value in row 1 at column 0. Accordingly, as shown in FIG. 4, the row pointer 462 includes row index 2 that points to the column pointer 464 that includes column index 0 (the starting non-zero column position for row 1). The value of that non-zero element,13, is an element of the array 466.

The sparse matrix 460 includes a non-zero value in row 2 at column 2. Accordingly, as shown in FIG. 4, the row pointer 462 includes row index 3 that points to the column pointer 464 that includes column index 2. The value of that non-zero element, 14, is an element of the array 466.

The sparse matrix 460 includes a non-zero values in row 3 at columns 1, 3, and 4. Accordingly, as shown in FIG. 4, the row pointer 462 includes row index 4 that points to the column pointer 464 that includes column indices 1, 3, and 4. The values of those non-zero elements, 15, 16, and 17 respectively, are elements of the array 466.

The sparse matrix 460 includes a non-zero values in row 4 at columns 0 and 2. Accordingly, as shown in FIG. 4, the row pointer 462 includes row index 7 that points to the column pointer 464 that includes column indices 0 and 2. The values of those non-zero elements, 18 and 19 respectively, are elements of the array 466. the row pointer 462 includes row index 9 that points to the end of the column pointer 464.

A DPE DSL compiler, for example the DPE compiler frontend 226 and backend 230 described in association with FIG. 2 above, can support sparse matrix representations, such as a CSR representation, by introducing specialized constructs in the DPE DSL to specify the three arrays of the CSR representation. This can enable efficient handling of sparse matrices in a DPE software development environment. The following pseudocode provides an example of such constructs:

template<typename T>
CSRMatrix(std::vector<uint32_t> rowPtr,

std::vector<uint32_t> columnPtr,
std::vector<T> values);

The size of a matrix on which a crossbar, such as the crossbars 106 described in association with FIG. 1 above, can perform MVM operations is limited. The dimensions of a matrix on which a crossbar can perform MVM operations can be expressed as MVMU_WIDTH×MVMU_WIDTH. The maximum vector length supported by a crossbar is also MVMU_WIDTH. Thus, a single crossbar may not be able to perform an MVM operation on a sparse matrix as a whole if the dimensions of the sparse matrix exceed MVMU_WIDTH×MVMU_WIDTH. Examples of the present disclosure include partitioning a sparse matrix into a plurality of submatrices of dimensions MVMU_WIDTH×MVMU_WIDTH. A vector can be partitioned into a plurality of subvectors, each of length MVMU_WIDTH. However, because a sparse matrix includes mostly elements that are zeroes, a partitioning strategy that expands the CSR representation back into the original sparse matrix would be a significant demand on the host memory. In contrast, the disclosed approaches avoid expanding sparse matrix representations back into the original sparse matrix by partitioning a sparse matrix into a plurality of submatrices and inputting the submatrices into crossbars of a DPE.

In some examples, a row pointer of a CSR representation can be iterated through based on a dimension of crossbars (MVMU_WIDTH) to partition a sparse matrix into submatrices. Non-zero elements pointed to by a column pointer of a CSR representation for each row obtained from the row pointer can be placed into a submatrix. The respective column indices of the non-zero elements can be added to a vector representing metadata of the submatrix. If a column index is already in the vector because the corresponding column has multiple non-zero elements, then the column index is not added again to the vector. Once a submatrix is filled with a quantity of columns equal to MVMU_WIDTH, the procedure described above can be repeated for subsequent submatrices. The metadata is used to match the respective elements from the vector to be multiplied with an input matrix to form a result subvector of dimension MVMU_WIDTH. A subvector of each respective one of the submatrices can be identified based on the metadata. The metadata can be generated concurrently with partitioning the sparse matrix. The subvector can be identified using the metadata entries as an index into an input vector. The submatrix and the subvector form an input to a crossbar to perform an MVM operation. MVM operations can be performed, in parallel, on the subvector of each respective one of the submatrices and an input matrix using crossbars (e.g., of the DPE). The output from multiple crossbars can be summed up according to the row index of the original sparse matrix to form a result vector.

Although FIG. 4 describes an example using a CSR representation of a sparse matrix, the disclosure is not so limited. Examples consistent with the disclosure can be compatible with the following non-limiting examples of sparse matrix representations: COO, CSC, ELL, DIA, and HYB.

FIG. 5 illustrates example partitioning of a sparse matrix 570 into submatrices 572 consistent with the disclosure. The submatrices 572-1, 572-2, . . . 572-k are collectively referred to as the submatrices 572. In the example of FIG. 5, the dimensions of the sparse matrix 570 is twelve rows by twelve columns and the dimensions of the crossbars, such as the crossbars 106 described in association with FIG. 1 above, are three rows by three columns. However, examples consistent with the disclosure are not so limited. Sparse matrices can have fewer or greater than twelve rows, twelve columns, or twelve rows and columns. Crossbars can support fewer or greater than three rows, three columns, or three rows and columns.

FIG. 5 illustrates partitioning of the sparse matrix 570 into the submatrices 572 based on a CSR representation of the sparse matrix 570. Because MVMU_WIDTH is three, the sparse matrix 570 is partitioned in groups of three rows. As shown in FIG. 5, the first three rows of the sparse matrix 570 has non-zero elements in columns 1, 3, 6, 8, 10, and 11. Again, because MVMU_WIDTH is three, the sparse matrix 570 is partitioned in groups of three columns. Thus, as shown in FIG. 5, the submatrix 572-1 includes the elements of rows 0, 1, and 2 and columns 1, 3, and 6 of the sparse matrix 570 and the submatrix 572-2 includes the elements of rows 0, 1, and 2 and columns 8, 10, and 11 of the sparse matrix 570. The submatrix 572-k includes the elements of rows 9, 10, and 11 and columns 3, 5, and 11 of the sparse matrix 570. Although not specifically illustrated in FIG. 5, additional submatrices can be formed between the submatrix 572-2 and the submatrix 572-k to fully partition the sparse matrix 570 according to the CSR representation of the sparse matrix 570.

Each of the submatrices 572 have a corresponding one of the subvectors 574. The subvectors 574-1, 574-2, . . . 574-k are collectively referred to as the vectors 574. Each of the subvectors 574 includes metadata for a corresponding one of the submatrices 572. The vector 574-1 includes the column indices of the sparse matrix 570 that are included in the submatrix 572-1, column indices 1, 3, and 6. Similarly, the vector 574-2 includes the column indices of the sparse matrix 570 that are included in the submatrix 572-2, column indices 8, 10, and 11, and the vector 574-k includes the column indices of the sparse matrix 570 that are included in the submatrix 572-k, column indices 3, 5, and 11.

An example method consistent with the present disclosure can include sorting, for each row of a sparse matrix, column indices of the sparse matrix that include non-zero elements in increasing order and rearranging the non-zero elements according to their respective column indices. For each MVMU_WIDTH quantity of rows of the sparse matrix, the column indices of the column pointer can be iterated through to find the lowest column index. Iterating through the column pointer can include obtaining the respective first column index.

For each MVMU_WIDTH quantity of rows of the sparse matrix, a tuple including a row index, a column index, and the value of each non-zero element can be generated and inserted into a list. The list of tuples can be sorted by the column indices. The lowest column index can be obtained. If the corresponding column of the submatrix already has a non-zero element of the sparse matrix, then the corresponding metadata has already been set and the non-zero element can be added to the submatrix. Otherwise, the column index can be added to the metadata and the non-zero element can be added to the next column of the sub-matrix. The next non-zero element for the same row can be obtained, a tuple can be formed, and the tuple can be added to the sorted list using an insertion sort, for example. This process can continue until the MVMU_WIDTH quantity of columns has been added to the submatrix. The submatrices can be initialized with all zeroes such that the non-zero values added to the sparse matrix replace zero values of the submatrix.

Once the MVMU_WIDTH quantity of columns has been added to the submatrix, a new submatrix can be formed. This can continue for the next set of the MVMU_WIDTH quantity of rows until all the rows of the sparse matrix are processed (the end of the row pointer is reached).

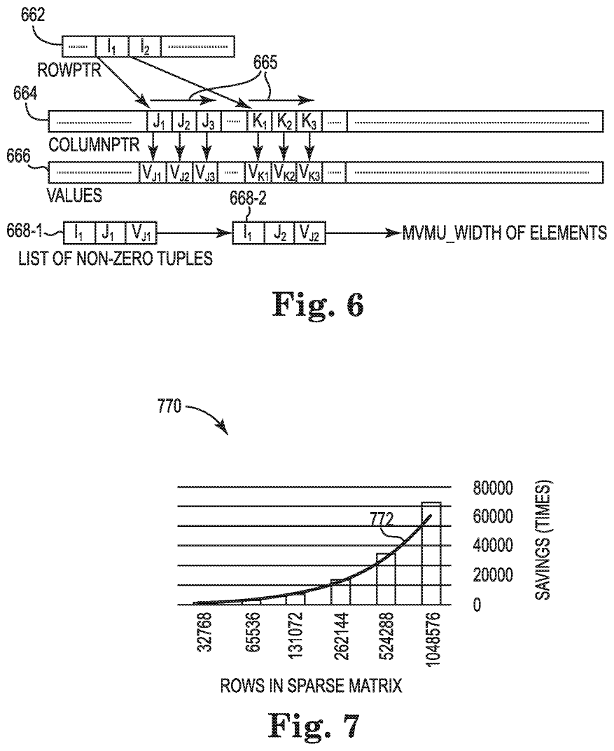

FIG. 6 illustrates an example iteration through a CSR representation of a sparse matrix consistent with the disclosure. In the example of FIG. 6, the dimensions of the crossbars, such as the crossbars 106 described in association with FIG. 1 above, are MVMU_WIDTH rows by MVMU_WIDTH columns. As described above, a CSR representation of a sparse matrix includes a row pointer (RowPtr) 662, a column pointer (ColumnPtr) 664, and an array 666 of values. The row pointer 662 includes starting non-zero position of a row in the column pointer, such as I₁ and I₂, of a sparse matrix that includes non-zero elements. The column pointer 664 includes column indices, such as J₁, J₂, J₃, K₁, K₂, and K₃ of the sparse matrix that includes non-zero elements. The array 666 includes the values of the non-zero elements of the sparse matrix at the corresponding column indices, V_{J1}, V_{J2}, V_{J3}, V_{K1}, V_{K2}, and V_{K3}.

As indicated by the horizontal arrows 665, in each iteration MVMU_WIDTH worth of rows are traversed. Row index I₁ of the row pointer 662 points to column index J₁ of the column pointer 664. Value V_{J1} is the value of the non-zero element at row index I₁ and column index J₁, value V_{J2} is the value of the non-zero element at row index I₁ and column index J₂, and value V_{J3} is the value of the non-zero element at row index I₁ and column index J₃ and so on. The first non-zero element for the row I₁ can make a tuple consisting I₁, J₁, V_{J1} and can be inserted in the list of non-zero tuples 668.

Row index I₂ of the row pointer 662 points to column index K₁ of the column pointer 664. Value V_{K1} is the value of the non-zero element at row index I₂ and column index K₁, value V_{K2} is the value of the non-zero element at row index I₂ and column index K₂, and value V_{K3} is the value of the non-zero element at row index I₂ and column index K₃. The first non-zero element for the row I₂ can make a tuple consisting I₂, K₁, Vₖ₁ and can be inserted in the list of non-zero tuples 668. The process described above can continue for a MVMU_WIDTH quantity of rows.

The list of tuples 668 can be sorted based on the increasing column value order of each tuple. Each element from the list of tuples 668 head can be removed and the value from each of the tuples can be inserted in the columns of the submatrix in the increasing order. The column position of each value in the input matrix, indicated by the second value in the tuple, can be added into the submatrix metadata (e.g., into the subvector 574-1). If a value for the same column is already added, this step may be ignored. A new non-zero entry for the same row is determined and added in appropriate position in the already sorted tuple list 668-1. This process continues until MVMU_WIDTH quantity of columns have been added into the submatrix. Further non-zero elements can be added into a new submatrix. This process continues until all the elements for MVMU_WIDTH quantity of rows are processed.

Although FIGS. 4-6 illustrate examples consistent with the disclosure using a CSR representation of a sparse matrix, the disclosure is not so limited. For example, a CSC representation of a sparse matrix can be used. In contrast to iterating through a row pointer and then a column pointer of a CSR representation, an example consistent with the disclosure can iterating through a column pointer and then a row pointer of a CSC representation. A list of tuples can be generated, each tuple including a column index, a row index, and the value of a non-zero element of a sparse matrix represented using CSC notation.

FIG. 7 is a graph 770 showing example memory savings consistent with the disclosure. In the example of FIG. 7, an R-MAT generated sparse matrix with edge factor of four was used. The graph illustrates the savings in host memory requirements against various quantities of rows of the square sparse matrix. As shown by the line 772, the memory savings increases in direct correlation to the size of the sparse matrix. For example, partitioning a sparse matrix of size 1048576×1048576 (a scale of 220) with edge factor 4 consistent with the disclosure can require 60,000 times less memory to store the partitioned sparse matrix relative to the host memory requirements of the sparse matrix as a whole.

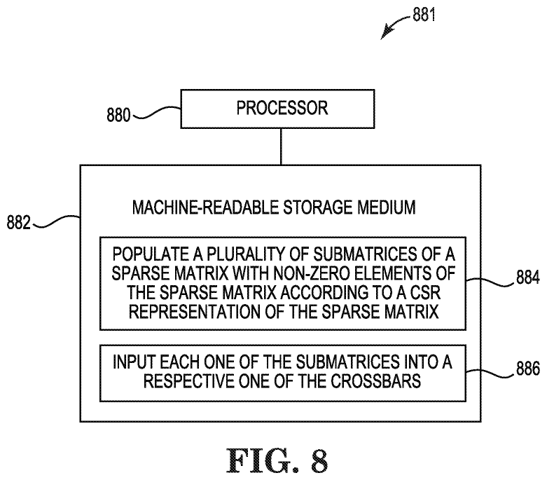

FIG. 8 is a block diagram of an example system 881 consistent with the disclosure. In the example of FIG. 8, the system 881 includes a processor 880 and a machine-readable storage medium 882. Although the following descriptions refer to a single processor and a single machine-readable storage medium, the descriptions may also apply to a system with multiple processors and multiple machine-readable storage mediums. In such examples, the instructions can be distributed across multiple machine-readable storage mediums and the instructions may be distributed across multiple processors. Put another way, the instructions can be stored across multiple machine-readable storage media and executed across multiple processors, such as in a distributed computing environment.

The processor 880 can be a central processing unit (CPU), a microprocessor, and/or other hardware device suitable for retrieval and execution of instructions stored in the machine-readable storage medium 882. In the particular example shown in FIG. 8, the processor 880 can receive, determine, and send instructions 884 and 886. As an alternative or in addition to retrieving and executing instructions, the processor 880 can include an electronic circuit comprising a number of electronic components for performing the operations of the instructions in the machine-readable storage medium 882. With respect to the executable instruction representations or boxes described and shown herein, it should be understood that part or all of the executable instructions and/or electronic circuits included within one box may be included in a different box shown in the figures or in a different box not shown.

The machine-readable storage medium 882 can be any electronic, magnetic, optical, or other physical storage device that stores executable instructions. Thus, the machine-readable storage medium 882 can be, for example, Random Access Memory (RAM), an Electrically-Erasable Programmable Read-Only Memory (EEPROM), a storage drive, an optical disc, and the like. The executable instructions can be “installed” on the system 881 illustrated in FIG. 8. The machine-readable storage medium 882 can be a portable, external or remote storage medium, for example, that allows the system 881 to download the instructions from the portable/external/remote storage medium. In this situation, the executable instructions can be part of an “installation package.” As described herein, the machine-readable storage medium 882 can be encoded with executable instructions for partitioning a sparse matrix according to a sparse matrix representation.

The instructions 884, when executed by a processor such as the processor 880, can cause the system 881 to populate a plurality of submatrices of a sparse matrix with non-zero elements of the sparse matrix according to a CSR representation of the sparse matrix. Dimensions of the submatrices can be equal to dimensions of a plurality of crossbars.

Instructions 886, when executed by a processor such as the processor 880, can cause the system 881 to input each one of the submatrices into a respective one of the crossbars.

Although not specifically illustrated in FIG. 8, the machine-readable storage medium 882 can include instructions, when executed by a processor such as the processor 880, can cause the system 881 to traverse a row pointer of the CSR representation of the sparse matrix according to a height of the crossbars and traverse, from the row pointer, a column pointer of the CSR representation of the sparse matrix according to a width of the crossbars. Each row of each respective one of the submatrices can be populated with non-zero elements of the sparse matrix at column indices according to the traversal of the column pointer and the row pointer.

Although not specifically illustrated in FIG. 8, the machine-readable storage medium 882 can include instructions, when executed by a processor such as the processor 880, can cause the system 881 to, for each respective one of the submatrices, populate a subvector with values of the respective submatrix and input the subvector and the respective submatrix into the respective one of the crossbars. In some examples, the respective submatrix is written to the respective crossbars and subsequently, the sub-vector multiplied with the respective submatrix such that the submatrix and subvector are not input to the respective crossbar concurrently. MVM operations can be performed in parallel on the subvectors and an input matrix using the crossbars. The plurality of submatrices can be initialized with zeros prior to populating the plurality of submatrices with non-zero elements of the sparse matrix according to the CSR representation of the sparse matrix.

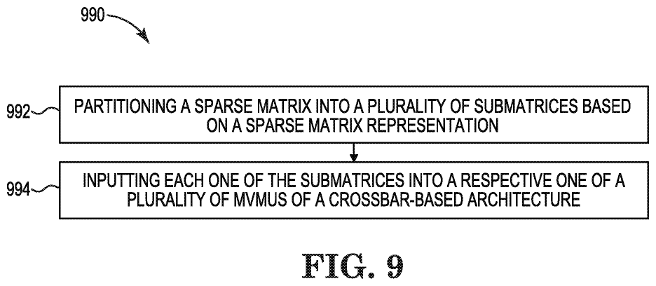

FIG. 9 illustrates an example method 990 consistent with the disclosure. At 992, the method 990 can include partitioning a sparse matrix into a plurality of submatrices based on a sparse matrix representation. Partitioning the sparse matrix can include, for each row of the sparse matrix, sorting non-zero column positions of the sparse matrix representation in increasing order and rearranging non-zero elements of the sparse matrix according to the indices. Partitioning the sparse matrix can include traversing a first pointer associated with a first dimension of the sparse matrix and iterating through non-zero elements of the sparse matrix according to a second pointer associated with a second dimension of the sparse matrix. In some examples, the sparse matrix representation can be a CSR representation or a CSC representation.

At 994, the method can include inputting each one of the submatrices into a respective one of a plurality of MVMUs of a crossbar-based architecture. In some examples, each one of the submatrices can be input into a respective one of a plurality of MVMUs of a DPE. In some examples, partitioning the sparse matrix can be performed using a DSL compiler.

Although not illustrated in FIG. 9, the method 990 can include partitioning the sparse matrix into the plurality of submatrices based on dimensions of the MVMUs. The method 990 can include performing an MVM operation on the plurality of submatrices, in parallel, using the MVMUs.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Similar elements or components between different figures may be identified by the use of similar digits. Elements shown in the various figures herein can be added, exchanged, and/or eliminated so as to provide a plurality of additional examples of the present disclosure. In addition, the proportion and the relative scale of the elements provided in the figures are intended to illustrate the examples of the present disclosure and should not be taken in a limiting sense.

What is claimed:

1. A method, comprising:
partitioning a sparse matrix into a plurality of submatrices based on a sparse matrix representation; and
inputting each one of the submatrices into a respective one of a plurality of matrix-vector multiplication units (MVMUs) of a crossbar-based architecture.

2. The method of claim 1, wherein inputting each one of the submatrices includes inputting each one of the submatrices into a respective one of a plurality of MVMUs of a dot product engine (DPE).

3. The method of claim 1, wherein partitioning the sparse matrix includes partitioning the sparse matrix using a domain specific programming language (DSL) compiler.

4. The method of claim 1, further comprising partitioning the sparse matrix into the plurality of submatrices based on dimensions of the MVMUs.

5. The method of claim 1, further comprising performing a matrix-vector multiplication (MVM) operation on the plurality of submatrices, in parallel, using the MVMUs.

6. The method of claim 1, wherein partitioning the sparse matrix includes, for each row of the sparse matrix:
sorting non-zero column positions of the sparse matrix representation in increasing order; and
rearranging non-zero elements of the sparse matrix according to the indices.

7. The method of claim 1, wherein partitioning the sparse matrix includes:
traversing a first pointer associated with a first dimension of the sparse matrix; and
iterating through non-zero elements of the sparse matrix according to a second pointer associated with a second dimension of the sparse matrix.

8. The method of claim 1, wherein the sparse matrix representation is a compressed sparse row (CSR) representation.

9. The method of claim 1, wherein the sparse matrix representation is a compressed sparse column (CSC) representation.

10. A non-transitory processor readable medium, comprising machine executable instructions that, when executed by a processor, cause the processor to:
populate a plurality of submatrices of a sparse matrix with non-zero elements of the sparse matrix according to a compressed sparse row (CSR) representation of the sparse matrix, wherein dimensions of the submatrices are equal to dimensions of a plurality of crossbars; and
input each one of the submatrices into a respective one of the crossbars.

11. The non-transitory processor readable medium of claim 10, further comprising machine executable instructions that, when executed by the processor, cause the processor to:
traverse a row pointer of the CSR representation of the sparse matrix according to a height of the crossbars;
traverse, from the row pointer, a column pointer of the CSR representation of the sparse matrix according to a width of the crossbars; and
populate each row of each respective one of the submatrices with non-zero elements of the sparse matrix at column indices according to the traversal of the column pointer and the row pointer.

12. The non-transitory processor readable medium of claim 10, further comprising machine executable instructions that, when executed by the processor, cause the processor to:
for each respective one of the submatrices:
populate a subvector with values of the respective submatrix; and
input the subvector and the respective submatrix into the respective one of the crossbars; and
perform matrix-vector multiplication (MVM) operations, in parallel, on the subvectors and an input matrix using the crossbars.

13. The non-transitory processor readable medium of claim 10, further comprising machine executable instructions that, when executed by the processor, cause the processor to initialize the plurality of submatrices with zeros prior to populating the plurality of submatrices with non-zero elements of the sparse matrix according to the CSR representation of the sparse matrix.

14. A system, comprising:
a dot product engine (DPE) compiler to:
recognize at least one sparse matrix representation in a domain specific programming language (DSL); and
partition a sparse matrix into a plurality of submatrices based on the at least one sparse matrix representation; and
a DPE to:
receive the plurality of submatrices; and
perform matrix-vector multiplication (MVM) operations, in parallel, directly on the submatrices using tiles of the DPE.

15. The system of claim 14, wherein the at least one sparse matrix representation includes a set of three arrays described in the DSL.

16. The system of claim 15, wherein the set of three arrays includes:
a first array representing a row pointer of the sparse matrix representation;
a second array representing a column pointer of the sparse matrix representation; and
a third array including values of the sparse matrix representation.

17. The system of claim 14, wherein the DPE is to sum results of the MVM operations according to row indices of the sparse matrix to generate a result vector.

18. The system of claim 14, wherein:
the DPE compiler is to:
generate metadata for each respective one of the submatrices indicating to which column indices of the sparse matrix each respective one of the submatrices correspond; and
identify a subvector of each respective one of the submatrices based on the metadata; and
the DPE is to perform MVM operations, in parallel, on the subvector of each respective one of the submatrices and an input matrix using crossbars of the DPE.

19. The system of claim 18, wherein the DPE compiler is to generate the metadata concurrently with partitioning the sparse matrix.

20. The system of claim 18, wherein the DPE compiler is to identify the subvector using the metadata as an index into an input vector.
